(19) United States
(12) Patent Application Publication
(10) Pub. No.: US 2011/0058301 A1
(43) Pub. Date: Mar. 10, 2011

(54) COMPRESSION SPRING-TENSIONED EMITTER ELECTRODES FOR ION WIND FAN

(75) Inventor: Hui-Leng LIM, Sugar Land, TX (US)

(73) Assignee: Ventiva, Inc., Santa Clara, CA (US)

(21) Appl. No.: 12/862,680

(22) Filed: Aug. 24, 2010

Related U.S. Application Data
(60) Provisional application No. 61/236,476, filed on Aug. 24, 2009.

(51) Int. Cl. H01T 23/00

(52) U.S. Cl. 361/230

(57) ABSTRACT

One or more emitter electrodes of an ion wind fan can be held in tension by using a slider mechanism in contact with a compression spring. In one embodiment, an ion wind fan has an isolator with a cavity, and the slider movably located in the cavity. The fan further includes a spring located in the cavity, so that the slider compresses the spring when the slider moves in the cavity. An emitter wire is then attached to the isolator and to the slider so that the emitter is in tension.

### CROSS-REFERENCE AND PRIORITY CLAIM

The present application claims the priority benefit of U.S. Provisional Patent Application No. 61/236,476, filed on Aug. 24, 2009, entitled “Compression Spring-Tensioned Emitter Electrodes for an Ion Wind Fan,” which is hereby fully incorporated by reference.

### FIELD OF THE INVENTION

The embodiments of the present invention are related to ion wind fans, and in particular to a emitter electrode attachment for an ion wind fan.

### BACKGROUND

It is well known that heat can be a problem in many electronics device environments, and that overheating can lead to failure of components such as integrated circuits (e.g. a central processing unit (CPU) of a computer) and other electronic components. Most electronics devices, from LED lighting to computers and entertainment devices, implements some form of thermal management to remove excess heat.

Heat sinks are a common passive tool used for thermal management. Heat sinks use conduction and convection to dissipate heat and thermally manage the heat-producing component. To increase the heat dissipation of a heat sink, a conventional rotary fan or blower fan has been used to move air across the surface of the heat sink, referred to generally as forced convection. Conventional fans have many disadvantages when used in consumer electronics products, such as noise, weight, size, and reliability caused by the failure of moving parts and bearings.

A solid-state fan using ionic wind to move air addresses the disadvantages of conventional fans. However, providing an ion wind fan that meets the requirements of consumer electronics devices presents numerous challenges not addressed by any currently existing ionic wind device.

Three key components of an ion wind fan using a wire-based emitter electrode (also referred to as the corona electrode) are, a metal collector which is also the negative electrode or ground electrode, an emitter which is a metal wire serving as the positive electrode, and a plastic or other dielectric isolator structure which isolates the positive and negative electrode and also provides alignment features to align the collector and one or more emitter electrodes by establishing the spatial relationships between the electrodes. (The positive and negative electrode can be switched, i.e. negative corona electrode and positive or ground collector electrode)

In some prior art wire corona electrode applications, such as printers that use wires as the emitter for ink and/or paper charging, some form of extension spring is used to provide constant tension to the wire to maintain the performance of the wire as an emitter. Tensioning of the emitter using a spring can be advantageous because such tensioning can counter different expansion rates under temperature of the wire material and the material of the structure which the wire is attached to (referred to as the isolator), provide leeway for component tolerance stack up in production and during assembly, and prevent wire stretching and sagging due to any electromotive forces that the wire may see during operation of the fan.

### BRIEF DESCRIPTION OF THE DRAWINGS

FIG. 1 is a perspective view of an ion wind fan according to one embodiment of the present invention;

FIG. 2 is an upstream view of an ion wind fan according to one embodiment of the present invention;

FIG. 3 is an upstream plan view of a one-channel ion wind fan according to one embodiment of the present invention;

FIG. 4a is an upstream plan view of a two-channel ion wind fan according to one embodiment of the present invention;

FIG. 4b is an upstream plan view of a two-channel ion wind fan according to one embodiment of the present invention; and

FIG. 5 is an upstream plan view of a three-channel ion wind fan according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode, getter electrode, or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Emitter Electrode Attachment

Wire-based emitter electrodes are typically held in tension in various corona electrode applications. For example, in printers using corona electrodes for charging toner particles or paper surfaces, the corona electrode is held in tension by an extension spring. As another example, in the “Ionic Breeze” air purifier by Sharper Image, the corona electrode is held in tension by a large leaf spring to which the corona attaches. In these application, space is not at the same premium as inside consumer electronics products, such as laptops, projectors, and the like, where the space for a cooling fan can be very limited.

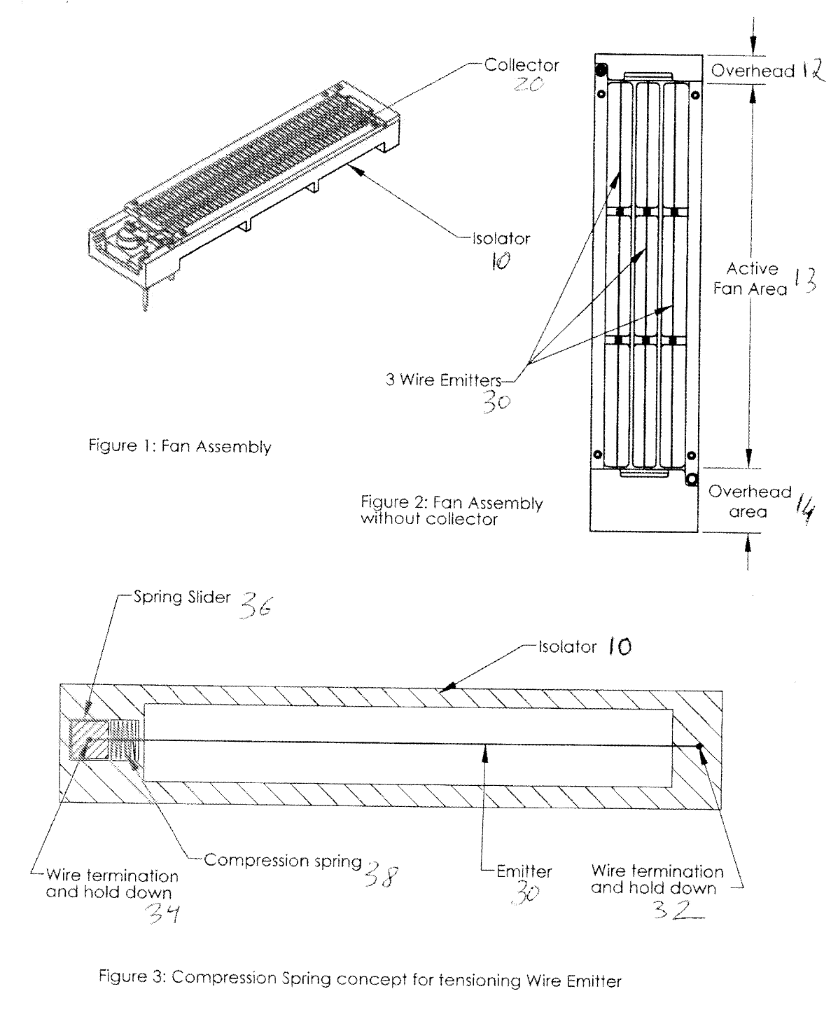

FIGS. 1 and 2 show one example of an ion wind fan in which embodiments of the present invention can be implemented. In some configurations, it is advantageous for the tensioning mechanism to be in the overhead areas because the springs, which are typically metal or contain metallic material, will not interfere with the corona, and the tensioning features will not get in the way of airflow. As can be seen from FIGS. 1 and 2, the overhead area 14 in which tensioning springs can be designed into is very limited. For some fan designs the overhead area is only approximately 7 mm by 8 mm, or about 55-60 mm², and many other features of the fan, such as electronic connections and fastening means also take up space in the overhead area. The direction of air flow is from the wire emitters towards the collector, so in FIG. 2, if there was a collector attached, the air will flow out of the page during operation of the ion wind fan.

On embodiment of the present invention is now described with reference to FIG. 3. FIG. 3 is a simplified cross-sectional top view of an ion wind fan, such as the fan shown in FIG. 1, with the collector electrode omitted for simplicity and ease of understanding. FIG. 3 shows a single emitter wire electrode 30 held in tension around the frame of an isolator element 10. The open area under the emitter wire allows air to flow freely.

On one side (the right side in FIG. 3), the wire emitter is terminated and attached to the isolator by a wire termination 32. The wire termination can be implemented as a plastic heat stake melted around the wire emitter, a post around which the wire emitter is wrapped, or using some other wire termination technique. On the opposite side of the fan (the left side in FIG. 3), the wire emitter is also terminated at a wire termination 34, but this wire termination 34 is a part of (of attached to) a spring slider assembly.

In FIG. 3, the spring slider 36 is represented as a square block that is situated inside a spring-slider cavity 41. A compression spring is also situated inside the spring-slider cavity 41, such that the compression spring 38 contacts the spring slider element 36 on one side and a wall of the spring-slider cavity 41 on the other side. The cavity 41 can have features that will guide the slider to move in the spring compression direction smoothly, and to restrict movement in undesired directions.

When the compression spring 38 is at fully relaxed, the spring slider element is situated substantially in the leftmost portion of the spring-slider cavity 41. As the spring slider moves to the right, sliding between the sidewalls of the cavity, the compression spring resists such rightward movement. Therefore, the wire emitter 30 can be held in tension by the two wire terminations, since one is in a fixed location relative to the isolator, while the other one is being pushed away from the fixed termination by the extension of the compression spring under compression.

Using FIG. 3 as an example, a manufacturing process for tensioning the electrodes, according to one embodiment, begins before assembly of the wire emitter with the compression spring being fully relaxed. The emitter wire is first terminated on the slider block side, leaving the other side free. During assembly, there are assembly fixtures that will pull the wire towards the right, compressing the spring, until the spring is fully or partially compressed. The design of the spring compression length, spring wire gauge and spring rate is based on the amount of tensioning that the emitter wire requires and the yield strength of the emitter wire. While the spring is compressed during the assembly process, the right end of the wire in FIG. 3 is terminated, leaving the spring to provide tensioning to the emitter wire in the ion wind fan.

As mentioned above, such a wire emitter electrode tensioning technique takes up significantly less space for both attachment and the spring length, which can be advantageous in a compact ion wind fan design. Furthermore, such a design allows for using dielectric material for the spring slider and wire termination on the spring slider, thus eliminating conductive contact between the metallic spring and the high voltage emitter electrode. FIG. 3 shown only one emitter electrode attached according to one embodiment of the present invention, but the same attachment technique can be duplicated side-by-side. Thus, the compression spring design is scalable for multiple emitter fan designs.

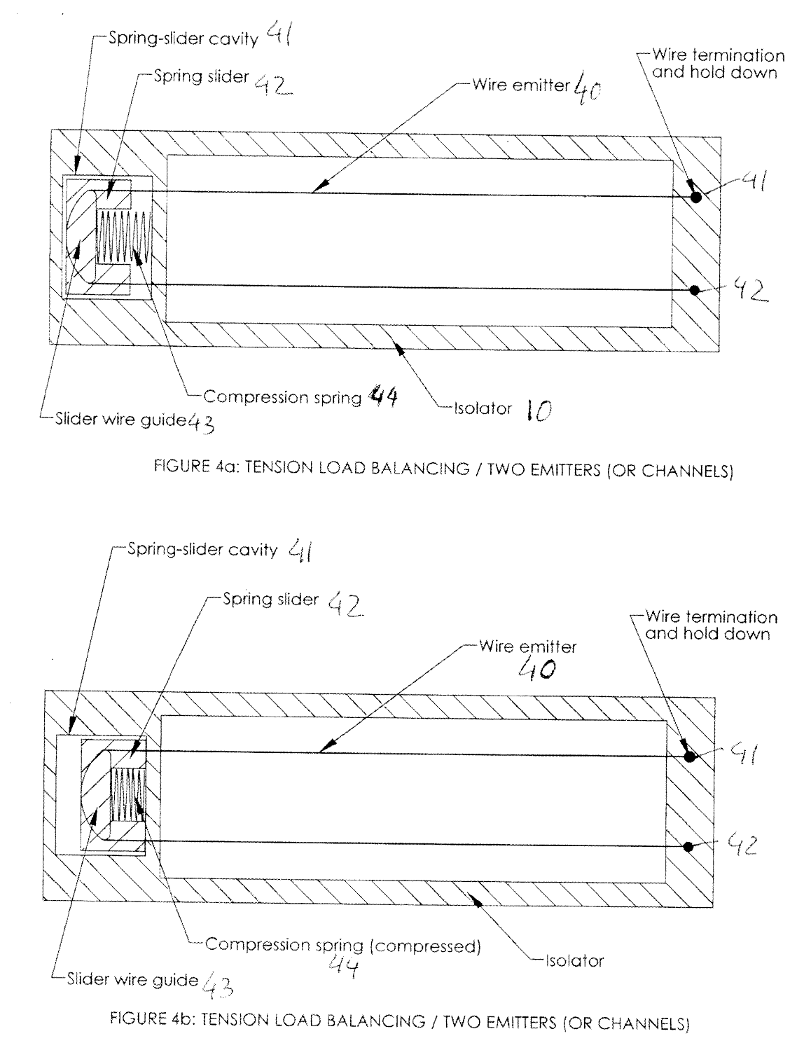

Duplicating the compression spring emitter tensioning technique to accommodate multiple emitters has the disadvantage of using multiple springs and spring sliders, which all take up limited overhead area resources. According to another embodiment of the present invention, multiple wire emitters can be held in tension using a single compression spring and spring slider mechanism. One such embodiment is now described with reference to FIGS. 4a and 4b.

Many aspects of the ion wind fan shown in FIG. 4a are substantially similar to those shown in and described with reference to FIG. 3. However, the fan in FIG. 4a has two emitter electrodes that are created out of a single wire. The wire 40 is held by the isolator 10 by two fixed wire terminations on one side of the isolator 42a, 42b. On the other side, there is still a spring slider 42 positioned inside a spring-slider cavity 41 and adjacent to a compression spring 44. However, instead of another wire termination, the spring slider element has a slider wire guide 43 protruding there from.

The single length of wire 40 is guided around 180 degrees by the slider wire guide 43. In the embodiment shown in FIG. 4a, the slider wire guide 43 also determines the spacing between the two emitter electrodes. In other embodiments, additional guide posts affixed to the isolator may pull or push the emitter electrodes further apart or closer together than the width of the slider wire guide.

In one embodiment, the slider wire guide has a rounded shape where contacted by the wire, in order to minimize friction forces on the wire and to evenly distribute the tensioning force of the spring amongst the two emitter electrodes. In some embodiments it can be advantageous if the wire guide is made of or coated with a material having a low coefficient of friction between it and the wire. This can reduce friction and even out the tensioning of the emitters electrodes, and can prevent damage to the wire. Alternately, the slider wire guide can be replaced with a pulley system to reduce friction on the wire.

FIG. 4b shows the two-emitter configuration described with reference to FIG. 4a under spring compression. For example, it the coefficient of thermal expansion (CTE) of the isolator is greater than that of the wire used for the emitters, then, if the ion wind fan were to be placed in a hot environment, the isolator would expand physically more than the wire. In this case, the wire—as looped around the wire guide—would exert pressure on the spring slider, which would slide forward inside the spring-slider cavity, thereby compressing the compression spring and maintaining substantially consistent wire tension in the emitter electrodes.

For purposes of illustration, FIG. 4b shows the compression spring under maximum compression, since the body of the spring slider is contacting the isolator element in the direction of compression, preventing further movement of the spring slider. According to other embodiments, the compression spring may reach maximum compression before the spring slider would make contact with the isolator.

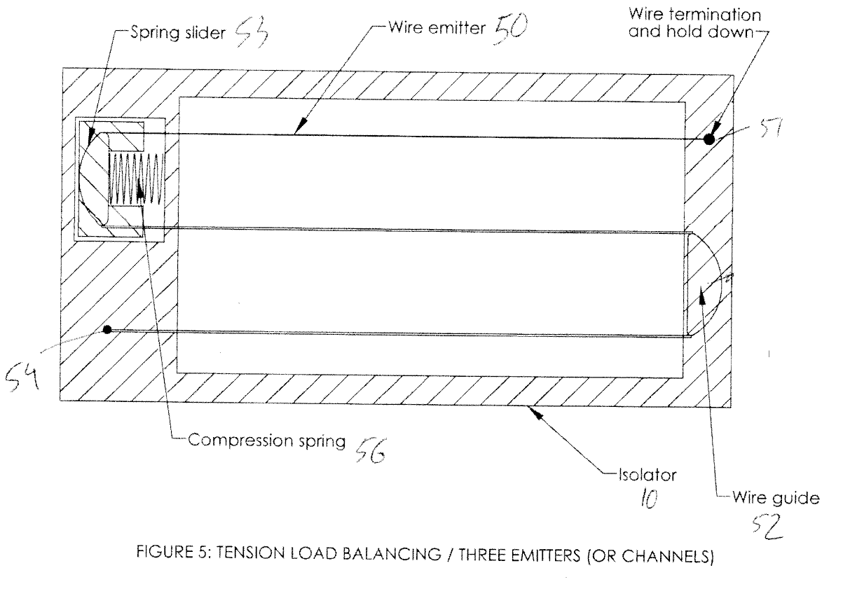

Yet another embodiment of the present invention is now described with reference to FIG. 5. FIG. 5 illustrates how to provide three emitter electrodes for an ion wind fan using a single wire 50, and a single compression spring 56 and spring slider 53 assembly. The spring slider assembly, including the compression spring 56, the spring slider 53 including the slider wire guide, and the spring slider cavity can be substantially similar to those described above with reference to FIGS. 4a and 4b. However, instead of the second wire termination on the same side as the first wire termination 51, another wire guide 52 is placed, and the wire is guided back towards the side of the isolator having the spring slider assembly. The wire is then terminated on the same side as the spring slider assembly using a second wire termination.

This fixed wire guide can be structurally similar to the slider wire guide. In one embodiment, it is rounded at least along the edge the contacts the wire. The fixed wire guide allows for some degree of sliding of the wire. Therefore, it is advantageous is the coefficient of friction between the fixed wire guide and the wire is low. This can help keep the tension of the three wire emitter electrodes substantially constant and alike. One example material suitable for reducing the coefficient of friction is Teflon coated plastic, but other such low-friction materials exist. Alternately, the fixed wire guide can be replaced with a frictionless or low-friction pulley system to reduce friction on the wire.

Theoretically, adding fixed wire guides similar to the one shown in FIG. 5 would allow for increasing the number of emitter electrodes provided from a single wire and tensioned using a single compression spring indefinitely. However, because of frictional losses, using currently widely available materials and construction techniques, approximately 3-4 is the maximum number of emitter electrodes that can be practically provided using a single wire-single spring configuration.

Other embodiments for providing multiple emitter electrodes including, for example, replicating the configuration shown in FIGS. 4a and 4b side by side to provide four emitters. In another embodiment having four emitters, the configuration shown in FIG. 4 can be provided twice so that the two spring slider assemblies are on opposite sides of the ion wind fan. Such an embodiment would use two wires, each used to create an emitter pair. The overhead area on both sides of the ion wind fan would have to be large enough to accommodate a spring slider assembly, such as that described with reference to FIGS. 4a and 4b.

In yet another embodiment having three emitter electrodes, a configuration like that described with reference to and shown in FIG. 3 (single electrode—single wire/spring) is disposed between an emitter pair configured like that shown in FIG. 4a. In other words, the spring slider assembly on the single wire emitter would be positioned between the two wire terminations of the single-wire emitter pair. Other similar electrode configurations are also possible.

While the example ion wind fan described and pictured above are shown as having 1-3 emitter electrodes, any number of emitter electrodes can be used. While most electronics cooling applications using a wire emitter will have between 1-10 emitter electrodes, the invention is not limited to any range of emitter electrodes used.

In the descriptions above, various functional modules are given descriptive names, such as “ion wind fan power supply.” The functionality of these modules can be implemented in software, firmware, hardware, or a combination of the above. None of the specific modules or terms—including “power supply” or “ion wind fan”—imply or describe a physical enclosure or separation of the module or component from other system components.

Furthermore, descriptive names such as “emitter electrode,” “collector electrode,” and “isolator,” are merely descriptive and can be implemented in a variety of ways. For example, the “collector electrode,” can be implemented as one piece of metallic structure, but it can also be made of multiple members spaced apart, and connected by wires or other electrical connections to the same voltage potential, such as ground.

Similarly, the isolator can be the substantially frame-like component shown in the Figures, but it can have various shapes. The electrodes and the isolator are not limited to any particular material; however, the isolator will generally be made of a dielectric material, such as plastic, ceramic, and other known dielectrics.

What is claimed:

1. An ion wind fan comprising:
an isolator comprising a cavity;
a slider movably located in the cavity;
a spring located in the cavity, so that a first end of the spring contacts a first wall of the cavity and a second end of the spring contacts the slider, and wherein the slider compresses the spring when the slider moves towards the first wall of the cavity;
an emitter wire to be electrically coupled to a high voltage power supply, wherein the emitter is attached to the isolator and to the slider.

2. The ion wind fan of claim 1, wherein the ion wind fan has a longitudinal axis and the isolator comprises a first end and a second end longitudinally opposite to the first end, the emitter wire has a first end and a second end, and wherein the first and second ends of the emitter wire are attached to the first end of the isolator.

3. The ion wind fan of claim 2, wherein the cavity is located in the second end of isolator.

4. The ion wind fan of claim 3, wherein slider comprises wire guide having curved surface, wherein the emitter wire contacts the wire guide at the curved surface and is supported by the wire guide.

5. The ion wind fan of claim 1, further comprising a collector electrode attached to the isolator, wherein the collector electrode is to be electrically coupled to the high voltage power supply to create a high potential difference between the emitter wire and the collector electrode.

6. The ion wind fan of claim 5, wherein creating the high potential difference between the emitter wire and the collector electrode results in ion wind in the direction from the emitter wire towards the collector electrode.
